(19) United States
(12) Patent Application Publication
(10) Pub. No.: US 2025/0197308 A1
(43) Pub. Date: Jun. 19, 2025

(54) SOIL ENHANCEMENT SYSTEM

(71) Applicant: Living Water Agriculture, LLC, Sheridan, WY (US)

(72) Inventors: Brandon Mason, Idaho Falls, ID (US); Joseph Brown, Poway, CA (US); Michael Kosty, Prince George (CA); Michael Hall, Houston, TX (US); Mark Spoone, Castle Rock, CO (US)

(21) Appl. No.: 18/980,977

(22) Filed: Dec. 13, 2024

Related U.S. Application Data
(60) Provisional application No. 63/609,825, filed on Dec. 13, 2023.

(51) Int. Cl. C05F 17/20; C05F 11/08; C05G 3/00

(52) U.S. Cl. CPC C05F 17/20; C05F 11/08; C05G 3/00

(57) ABSTRACT

A soil enhancement system comprising an open-system bioreactor; a soil enhancement mix; a soil enhancement composition; and an irrigation system in communication with said open-system bioreactor. The system may further comprise an auto-fill device, a recirculation pump. and an aerator. A method of soil enhancement comprising flowing fluid into an open-system bioreactor; disposing a soil enhancement mix into an open-system bioreactor; contacting the fluid with the soil enhancement mix to form a soil enhancement composition; flowing the soil enhancement composition out of the open-system bioreactor; and flowing the soil enhancement composition through an irrigation system.

### CROSS-REFERENCE TO RELATED APPLICATIONS

This application claims priority to and the benefit of the filing of U.S. Provisional Patent Application No. 63/609,825, entitled “SOIL ENHANCEMENT SYSTEM”, filed on Dec. 13, 2023, and the specification thereof is incorporated herein by reference.

### BACKGROUND OF THE INVENTION

### Field of the Invention (Technical Field)

The present invention relates to a soil enhancement system and method of applying a soil enhancement composition.

### BACKGROUND

The soil microbiome is one of the most diverse and dynamic ecosystems on the planet. It is found in the rhizosphere, which is the narrow region of soil that's directly influenced by root secretions. The soil microbiome is a diverse community of microorganisms that live in soil and includes bacteria, archaea, fungi, protozoa, and viruses. The soil microbiome has the potential to have both beneficial and harmful effects on plant growth and crop yield. Soil microbes underpin key benefits that soils provide, such as food production, the clean-up of pollutants, and carbon storage in soil organic matter.

Traditional agriculture biological inputs rely on a closed-system bioreactor to produce compositions that are later extracted from the bioreactor and distributed to a target soil and/or crop. What is needed is an open-system bioreactor that provides a continuous composition stream to a soil and/or crop without the need to extract the composition from the bioreactor and subsequently distribute the composition to the soil and/or crop.

### BRIEF SUMMARY OF THE INVENTION

Embodiments of the present invention relate to a soil enhancement system, the system comprising: an open-system bioreactor; a soil enhancement mix; a soil enhancement composition; and an irrigation system in communication with said open-system bioreactor. In another embodiment, the system further comprises an auto-fill device. In another embodiment, the system further comprises a recirculation pump. In another embodiment, the system further comprises an aerator.

In another embodiment, the soil enhancement composition comprises a microorganism. In another embodiment, the microorganism is a bacteria. In another embodiment, the microorganism is a fungi. In another embodiment, the soil enhancement composition comprises a sugar. In another embodiment, the soil enhancement composition comprises a bio-stimulant. In another embodiment, the soil enhancement composition comprises a carbohydrate. In another embodiment, the soil enhancement composition comprises carbon.

In another embodiment, the soil enhancement composition is at a pH of about 6.0 to about 9.0. In another embodiment, the soil enhancement composition is at a temperature of about 45 degrees Fahrenheit to about 95 degrees Fahrenheit. In another embodiment, the soil enhancement composition comprises a nitrogen fixing composition. In another embodiment, the soil enhancement composition comprises a phosphate fixing composition. In another embodiment, the system further comprises a communication module.

Embodiments of the present invention also relate to a method of soil enhancement, the method comprising: flowing fluid into an open-system bioreactor; disposing a soil enhancement mix into an open-system bioreactor; contacting the fluid with the soil enhancement mix to form a soil enhancement composition; flowing the soil enhancement composition out of the open-system bioreactor; and flowing the soil enhancement composition through an irrigation system. In another embodiment, the method further comprises aerating the soil enhancement composition. In another embodiment, the method further comprises recirculating the soil enhancement composition. In another embodiment, the method further comprises adjusting the pH of the soil enhancement composition.

Further scope of applicability of the present invention will be set forth in part in the detailed description to follow, taken in conjunction with the accompanying drawing, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawing, which is incorporated into and form a part of the specification, illustrates one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a diagram showing a soil enhancement system, according to an embodiment of the present invention; and

FIG. 2 is a diagram showing a soil enhancement system comprising a data and communication controller, according to an embodiment of the present invention.

### DETAILED DESCRIPTION OF THE INVENTION

Embodiments of the present invention relate to a soil enhancement system, the system comprising: a soil enhancement composition; an open-system bioreactor; an auto-fill device; a recirculation pump; and an aerator. The soil enhancement composition may comprise a microorganism, e.g., a bacteria or fungi, a bio-stimulant, a sugar, a carbohydrate, or a combination thereof.

Embodiments of the present invention also relate to a method for enhancing soil, the method comprising: flowing fluid into an open-system bioreactor; disposing a soil enhancement mix into an open-system bioreactor; contacting the fluid with the soil enhancement mix to form a soil enhancement composition; flowing the soil enhancement composition out of the open-system bioreactor; and flowing the soil enhancement composition through an irrigation system. The method may further comprise aerating and/or recirculating the soil enhancement composition.

The system and method may systematically introduce microbes, carbon, bio-stimulants, bacteria, fungi, and other components to the soil and crops during irrigation. The system and method may improve overall soil health and balance.

The system comprises a soil enhancement composition used in combination with a delivery method designed to regenerate and balance the soil microbiome and rhizosphere. The system and method comprise a microbial, a bio-stimulant, carbon, sugar, and other biologic elements in specific ratios for each individual soil enhancement composition. The system and method may provide a consistent and continuation flow of soil enhancement composition to a soil and/or crop from an open-system bioreactor.

The terms “fluid” or “fluids” as used herein includes, but is not limited to, water, an aqueous solution, a homogenous solution, a heterogeneous solution, or a combination thereof.

The terms “irrigate” or “irrigation” as used herein mean to contact a fluid with a soil or crop to improve the quality of the soil or growth of the crop.

The term “open-system” as used herein means a system in which mass or energy may be lost to or gained from the environment.

The term “closed-system” as used herein means a system where no reactants or products can escape and only heat may be exchanged freely.

The term “bioreactor” as used herein means an apparatus in which biological reaction or process is carried out.

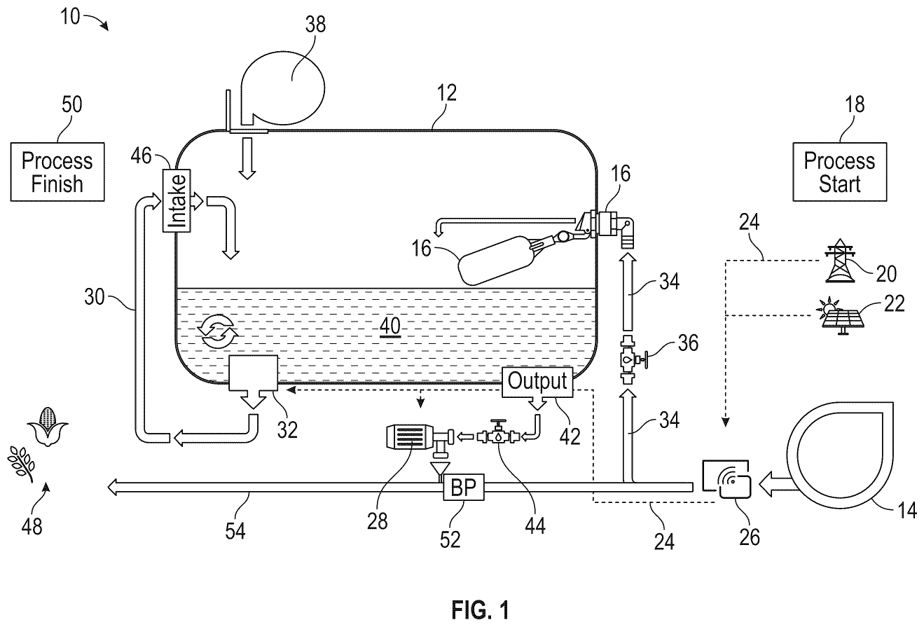

Turning now to the figures, FIG. 1 shows soil enhancement system 10. Soil enhancement system 10 comprises open-system bioreactor 12, interconnected to water source 14, equipped with auto-fill device 16 to maintain a continuous full capacity of fluid. Process start 18 comprises power sources 20 and/or 22 providing power 24 to soil enhancement system 10 including control box 26, injection pump 28, recirculation line 30, and aeration pump and/or recirculation pump 32. Control box 26 draws liquid water from water source 14 and conveys it through water supply line 34 into shutoff valve 36. Water from shutoff valve 36 enters open-system bioreactor 12 through auto-fill device 16. Fluid is then mixed with soil enhancement mix 38 to result in soil enhancement composition 40 inside of open-system bioreactor 12. Output 42 allows soil enhancement composition 40 to leave open-system bioreactor 12 and enter shutoff valve 44. Open-system bioreactor 12 requires aeration pump and/or recirculating pump 32 and/or recirculation line 30 for product circulation from the tank's bottom to its top. Aeration pump and/or recirculating pump 32 and recirculation line 30 are in communication with open-system bioreactor 12 via intake 46. Injection pump 28 is at least partially disposed on the output of open-system bioreactor 12, activated each time irrigation water is delivered to soil or crops 48 at process finish 50. Injection point blowback preventer 52 prevents blowback of soil enhancement composition 40 into open-system bioreactor 12. Simultaneous operation of auto-fill device 16 during the dispensation of soil enhancement composition 40 into irrigation line 54 sustains open-system bioreactor 12 at full capacity, replenishing fluid and oxygen levels. Continuous operation of recirculation line 30 aeration pump and/or recirculating pump 32 post-irrigation maintains the bioreaction.

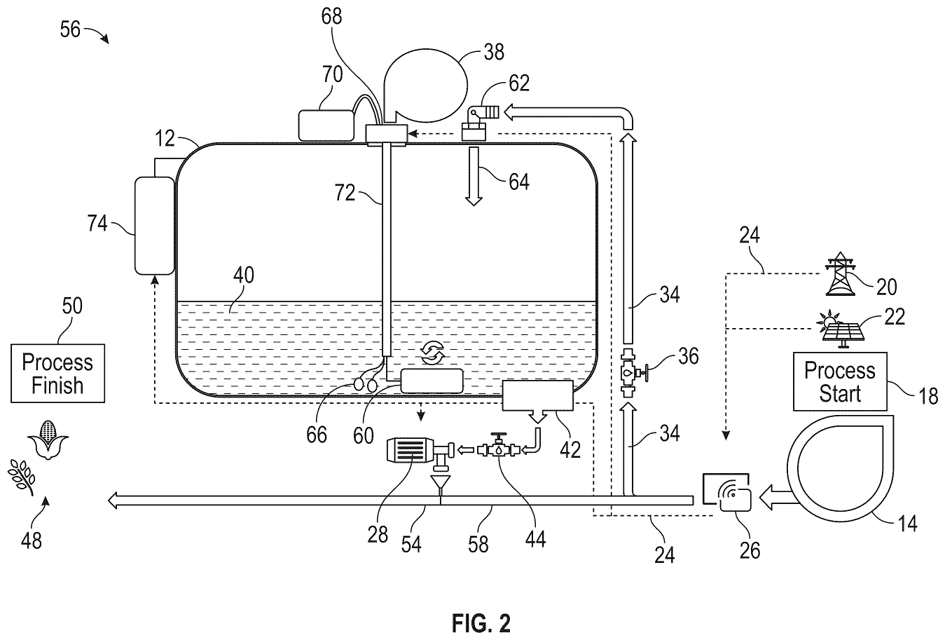

FIG. 2 shows soil enhancement system 56. Soil enhancement system 56 comprises open-system bioreactor 12, and interconnected to water source 14. Process start 18 comprises power sources 20 and/or 22 providing power 24 to soil enhancement system 56 including control box 26, and injection pump 28. Control box 26 draws liquid water from water source 14 and conveys it through water supply line 34 into shutoff valve 36. Water then passes through conduit 64 and enters open-system bioreactor 12 as flow 64. Fluid is then mixed with soil enhancement mix 38 to result in soil enhancement composition 40 inside of open-system bioreactor 12. Soil enhancement mix enters open-system bioreactor 12 through conduit 72. Aeration pump 70 is in communication with adapter 68 to provide air to open-system bioreactor 12 through conduit 72 and aeration air stones 66. Circulation pump 60 agitates soil enhancement composition 40. Communication module 74 receives data from one or more sensors within, or in proximity to, open-system bioreactor 12 and transmits the data a wireless network. Output 42 allows soil enhancement composition 40 to leave open-system bioreactor 12 and enter shutoff valve 44. Injection pump 28 is at least partially disposed on the output of open-system bioreactor 12, activated each time irrigation water is delivered to soil or crops 48 via conduct 54 at process finish 50. Conduit 58 supplies make-up water to soil enhancement composition 40 to adjust the concentration of enhancement composition 40 before it reaches process finish 50.

The system may comprise an open-system bioreactor. The open system bioreactor may comprise a vessel, inlet, and outlet. The open-system bioreactor allows for the ingress and egress of matter and energy and is in communication with the environment. The open-system bioreactor may be in communication with an auto-fill device, injection pump, and/or irrigation system.

The system and method may comprise an injection pump. The injection pump may operate at a flow rate at least about 0.5 gallon per acre (“gal./acre”), about 0.5 gal./acre to about 3 gal./acre, about 1 gal./acre to about 2.5 gal./acre, about 1.5 gal./acre to about 2 gal./acre, or about 3 gal./acre. The injection pump may be operated when irrigation is performed. The size of the open-system bioreactor may be increased with increasing irrigated acres. The open-system bioreactor may be adequately sized to apply a given gallon per acre. For example, a 100-acre field may require an open-system bioreactor with a capacity of at least about 100 gallons, and a 250-acre field may require an open-system bioreactor with a capacity of about 250 gallons. The auto-fill device may adjust the level of fluid in the open-system bioreactor. For example, an open-system bioreactor may comprise a 1000-gallon capacity with an auto-fill device set to maintain a 100-gallon level. During the injection of soil enhancement composition into irrigation line, the auto-fill device may maintain continuous open-system bioreactor volume to facilitate the addition of fresh water and oxygen to sustain a bioreaction. The auto-fill device may operate during the injection of the soil enhancement composition into an irrigation line.

The system and method may comprise an auto-fill device. The auto-fill device may flow fluid into the open-system bioreactor based on the number of acres being irrigated.

The system and method may comprise a fluid. The fluid may be at a pH of at least about 6.0, about 6.0 to about 9.0, about 6.5 to about 8.5, about 7.0 to about 8.0, about 7.2 to about 7.8, or about 9.0. The pH of the fluid may be adjusted by contacting the fluid with an acid or base; contacting the fluid with a selective membrane; contacting the fluid with a buffer; other means of removing and/or adding hydrogen and/or hydroxide ions; or a combination thereof.

The fluid may be at a temperature of at least about 45 degrees Fahrenheit (“° F.”), about 45° F. to about 95° F., about 50° F. to about 90° F., about 55° F. to about 85° F., about 60° F. to about 80° F., about 65° F. to about 75° F., or about 95° F. The temperature may be adjusted by contacting the fluid with heat, solar radiation, other radiation, or a combination thereof.

The soil enhancement composition may be an aqueous solution. The soil enhancement composition may be at a pH of at least about 6.0, about 6.0 to about 9.0, about 6.5 to about 8.5, about 7.0 to about 8.0, about 7.2 to about 7.8, or about 9.0. The pH of the soil enhancement composition may be adjusted by contacting the soil enhancement composition with an acid or base; contacting the soil enhancement composition with a selective membrane; contacting the soil enhancement composition with a buffer; other means of removing and/or adding hydrogen and/or hydroxide ions; or a combination thereof.

The soil enhancement composition may be at a temperature of at least about 45 degrees Fahrenheit (“° F.”), about 45° F. to about 95° F., about 50° F. to about 90° F., about 55° F. to about 85° F., about 60° F. to about 80° F., about 65° F. to about 75° F., or about 95° F. The temperature may be adjusted by contacting the fluid with heat, solar radiation, other radiation, or a combination thereof.

The system and method may comprise an aeration pump and/or recirculation line. The aeration pump and/or recirculation line may operation continuously to maintain the reaction inside the open-system bioreactor. The aeration pump and/or recirculation line may operate during the irrigation of a soil and/or crop or during a period of non-irrigation. Aeration and recirculation may be activated through aeration pump and recirculation line, respectively.

The soil enhancement composition may comprise a ratio of specific microorganisms, bio-stimulants, carbon, sugar, and other biologic components that may be contracted, e.g., infused, into the soil and/or onto a crop. The soil enhancement composition may be designed to offset and correct the damage and imbalance caused by overuse and overapplication of a conventional fertilizer including, but not limited to, a nitrogen, phosphorous, potassium, and/or carbon fertilizer. The soil enhancement composition may also be designed to convert and/or increase the rate of conversion of prior crop residue into available organic nutrients. The soil enhancement composition may allow the agricultural products, e.g., a plant or crop, to access unused nutrients and organic matter already in the soil but that was in an unusable state of condition. These soil enhancement composition may create significant improvements in crop yield, nutrient density, and/or overall plant performance.

The soil enhancement composition may comprise a spectrum of microbials, bio-stimulants, carbon, sugar and more that are designed to regenerate, balance, and re-energize soil by increasing biodiversity of soils to increase overall plant health and yield. The soil enhancement composition may comprise a microbial-based soil inoculant. The soil enhancement composition may also comprise a mycorrhizal fungi, a rhizosphere bacteria, an actinobacteria, a fungi, other bacteria promote plant growth, or a combination thereof. The soil enhancement composition may promote bio-diversity in a soil, may increase crop yield, may increase soil tilth, nutrient solubilization, nutrient mineralization, and a combination thereof.

The soil enhancement composition may comprise a microbial synergist, including but not limited to, sucrose, dextrose, humic acid (leonardite), hydrolyzed soy protein, brewer's yeast extract, kelp (e.g., Ascophyllum Nodosum), or a combination thereof. The microbial synergist may be at a concentration of at least about 1%, about 1% to about 30%, about 2% to about 25%, about 5% to about 20%, about 10% to about 15%, or about 30% by weight.

The soil enhancement composition may comprise a microorganism including, but not limited to, a fungus of the Glomus, Pisolithus, or Rhizopogon genus, or a combination thereof. The fungus of the Glomus genus includes, but is not limited to, Glomus Intraradices, Glomus Mosseae, Glomus Deserticola, Glomus Fasciculatum, Glomus Clarum, Glomus Microaggregatum, Glomus Monosporum, or a combination thereof. The fungus of the Glomus genus may be at a concentration of at least about 5 propagules/gram, about 5 propagules/gram to about 25 propagules/gram, about 10 propagules/gram to about 20 propagules/gram, about 12 propagules/gram to about 15 propagules/gram, or about 25 propagules/gram. The fungus of the Pisolithus or Rhizopogon genus includes, but is not limited to, Pisolithus Tinctorius, Rhizopogon Villosullus, Rhizopogon Luteolus, Rhizopogon Amylopogon, Rhizopogon Amylopogon, or a combination thereof. The fungus of the Pisolithus or Rhizopogon genus may be at a concentration of at least about 1,000 spores/gram, about 1,000 spores/gram to about 100,000 spores/gram, about 5,000 spores/gram to about 90,000 spores/gram, about 10,000 spores/gram to about 80,000 spores/gram, about 20,000 spores/gram to about 70,000 spores/gram, about 30,000 spores/gram to about 60,000 spores/gram, about 40,000 spores/gram to about 50,000 spores/gram, or about 100,000 spores/gram.

The soil enhancement composition may comprise a bacteria of the Bacillus, Pseudomonas, Streptomyces, or Trichoderma genus, or a combination thereof. The bacteria may include, but is not limited to, Bacillus Subtilis, Bacillus Firmus, Bacillus Licheniformis, Bacillus Amyloliquefaciens, Bacillus Coagulans, Bacillus Pasteurii, Bacillus Megaterium, Bacillus Pumilus, Paenibacillus Durum, Paenibacillus Polymyxa, Pseudomonas Fluorescens, Pseudomonas Putida, Pseudomonas Aureofaciens, Streptomyces Lydicus, Streptomyces Griseus, Streptomyces Coelicolor, Trichoderma Harzianum, Trichoderma Reesei, or a combination thereof. The bacteria may be at a concentration of at least about 10 million Colony Forming Units (“CFU”)/gram, about 10 million CFU/gram to about 120 million CFU/gram, about 20 million CFU/gram to about 110 million CFU/gram, about 30 million CFU/gram to about 100 million CFU/gram, about 40 million CFU/gram to about 90 million CFU/gram, about 50 million CFU/gram to about 80 million CFU/gram, about 60 million CFU/gram to about 70 million CFU/gram, or about 120 million CFU/gram.

The soil enhancement composition may comprise a nitrogen fixing composition. The nitrogen fixing composition may fix nitrogen present in soil, but in a form that is unusable by plants. The nitrogen fixing composition may comprise soil fixing microorganisms that may stimulate and/or support the rhizosphere and microbes to convert atmospheric nitrogen or ammonium nitrogen into nitrate compounds usable by plants. The nitrogen fixing composition may comprise a plurality of strains of nitrogen-fixing Rhizobia Bradyrhizobium Japonicum. The Bradyrhizobium may be cultured by a sui generis fermentation process that facilitates nodulation. The nitrogen fixing composition may also comprise a plurality of genera of free-living nitrogen-fixing bacteria that may inhabit the rhizosphere. The nitrogen fixing composition may further comprise a phosphate solubilizing bacteria that may enhance the nodulation process.

The nitrogen fixing composition may comprise a plurality of microorganisms to improve or maximize nitrogen fixation. Nitrogen fixing Rhizobia and free-living nitrogen-fixing may provide plants with plant-available nitrogen. The nitrogen fixing composition may be augmented with phosphorous-solubilizing bacteria, which positively influence nodulation. The nitrogen fixing may also comprise a growth factor to enhance microbial proliferation under field conditions.

Bradyrhizobium may be grown via a sui generis fermentation methodology. Sui generis fermentation may stimulate the production of high Levels of polysaccharide-degrading (e.g., hydrolytic) enzymes. The Bradyrhizobium may use the hydrolytic enzymes to create erosion pits in the epidermal cells of the plant, which permits the Rhizobia to gain access to the root where it occupies the nodule and begins the process of nitrogen fixation. The nitrogen fixing composition may comprise a free-living nitrogen-fixing microorganism which may inhabit the rhizosphere (soil influenced by root). Select Paenibacillus and Azospirillum bacterial species may convert atmospheric di-nitrogen (N₂) into plant available ammonia (NH₃). The nitrogen fixing composition may comprise aerobic and facultative organisms to ensure nitrogen fixation in a variety of soil microclimates.

The nitrogen fixing composition may comprise a bacteria of the genus Bradyrhizobium, Bacillus, Paenibacillus, Azospirillum, or a combination thereof. The bacteria may include, but is not limited to, Bradyrhizobium Japonicum, Bacillus Megaterium, Paenibacillus Polymyxa, Azospirillum Lipoferum, or a combination thereof. The bacteria may be at a concentration of at least about 1×108 CFU/gram, about 1×108 CFU/gram to about 6×108 CFU/gram, about 2×108 CFU/gram to about 5×108 CFU/gram, about 3×108 CFU/gram to about 4×108 CFU/gram, or about 6×108 CFU/gram.

The soil enhancement composition may comprise a phosphate fixing composition. The phosphate fixing composition may promote the mycorrhizal associations with fungi in the rhizosphere that convert organic forms of phosphorous, e.g., phytic acid, into usable forms available to the plant. The phosphate fixing composition may comprise a fungi and a bio-stimulant that allow the plants to consume phosphorous from soil. Phosphate consumption allows the plant to feed sugar back into the soil to feed the microbials. The phosphate fixing composition may promote phosphate solubilization and/or phosphate mineralization in soil. The phosphate fixing composition may also increase crop yield and/or enhance crop quality, which may reduce the supplemental phosphate requirement. The phosphate fixing composition may also increase available phosphorus, enhance root growth, bud formation, and flowering and fruit production. The phosphate fixing composition may increase available phosphorus that is used to produce plant structural components including, but not limited to, protein, enzymes, DNA, nucleic acids, or a combination thereof.

The phosphate fixing composition may comprise a microbial synergist including, but not limited to, dextrose, sucrose, humic acid, soy protein, or a combination thereof. The microbial synergist may enhance the growth of beneficial microorganisms.

The phosphate fixing composition may promote phosphate solubilization and mineralization in the soil profile. Select microbial species release secondary metabolites which convert insoluble phosphatic based compounds into plant available phosphorus (“P”). Solubilization may be accomplished through the release of low molecular weight organic acids. The carboxyl and hydroxyl group portion of the organic acids chelates the cations bound to them, which converts the insoluble inorganic P into plant available P. Mineralization may occur when enzymes split insoluble organic P from the organic residue associated with them which in turn converts the insoluble inorganic P into plant available P. Once converted, the plant may use soluble P to enhance root growth, promote bud formation and flowering, increase yield, and to produce structural plant components.

The phosphate fixing composition may comprise a bacteria of the genus Penicillium, Bacillus, Pseudomonas, Trichoderma, or a combination thereof. The bacteria may include, but is not limited to, Penicillium Bilaii, Bacillus Subtilis, Bacillus Licheniformis, Bacillus Megaterium, Bacillus Amyloliquefaciens, Pseudomonas Fluorescens, Pseudomonas Putida, Pseudomonas Chlororaphis, Trichoderma Harzianum, Trichoderma Viride, or a combination thereof. The bacteria may be at a concentration of at least about 75 million CFU/gram, about 75 million CFU/gram to about 300 million CFU/gram, about 100 million CFU/gram to about 275 million CFU/gram, about 125 million CFU/gram to about 250 million CFU/gram, about 150 million CFU/gram to about 225 million CFU/gram, about 175 million CFU/gram to about 200 million CFU/gram, or about 300 million CFU/gram.

The soil enhancement composition may be continuously agitated. The soil enhancement composition may be contacted, infused, and/or bubbled with a gas including, but not limited to, oxygen, carbon dioxide, nitrogen, or a combination thereof.

The system may comprise a soil enhancement mix. The soil enhancement mix may be contacted with a fluid to form a soil enhancement composition. The soil enhancement mix and fluid may be combined in a ratio of at least about 100:1, about 100:1 to about 1:100, about 90:1 to about 1:90, about 80:1 to about 1:80, about 70:1 to about 1:70, about 60:1 to about 1:60, about 50:1 to about 1:50, about 40:1 to about 1:40, about 30:1 to about 1:30, about 20:1 to about 1:20, about 10:1 to about 1:10, or about 1:100 soil enhancement mix to fluid. The soil enhancement mix may be replenished at least about once per day, about once per day to about once per three months, about once per week to about once per two months, about once per two weeks to about once per month, or about once per three months. Replenishing soil enhancement mix may prevent complete depletion of open-system bioreactor.

The input comprises a soil support composition and may be contacted with water or other aqueous solution in the open-system. The inputs and water and/or aqueous solution are combined, to form a soil enhancement composition that may be used to irrigate the target soil and/or crop. Water auto-fill device may replenish the water after each irrigation inside the open-system. The slow aeration pump and the recirculation line may maintain a fully aerobic environment to support the living micro-organisms in the soil enhancement composition and may be infused into the soil. Optionally the open-system may be disposed out of direct sunlight. The ambient water temperature may be maintained at a temperature of at least about 100° F. or less, about 100° F. to about 32° F., about 90° F. to about 40° F., about 80° F. to about 50° F., about 70° F. to about 60° F., or about 32° F.

The open-system comprising soil enhancement composition may be integrated with the existing irrigation system and soil enhancement composition may be delivered through the irrigation system and fed to soil or crops. The soil enhancement composition injection is performed at the time of irrigation. The concentration of soil enhancement composition may be reduced as the soil or crops are irrigated and the liquid storage tank is refilled. The soil enhancement composition may be added back into the open-system bioreactor water at least about one time per week, about one time per week to about ten times per week, about two times per week to about nine times per week, about three times per week to about eight times per week, about four times per week to about seven times per week, about five times per week to about six times per week, or about ten times per week, to achieve consistent levels of the soil enhancement composition.

The system and method may comprise an irrigation system. The irrigation system may comprise a conduit to convey fluid, e.g., the soil enhancement composition, to an area of soil and/or to a crop. The conduit may be a channel, a pipe, an aqueduct, a tube, a slide, a ditch, or other means of conveyance. The conduit may be of any shape, size, volume, length, and/or diameter.

The irrigation system may employ any known irrigation method including, but not limited to, pivot, drip, sprinkler, flood, or a combination thereof. The irrigation method may be used to irrigate an agricultural field, a greenhouse, a vertical farm, a grow house, a hydroponic farm, oil field, or a combination thereof.

The soil enhancement system may be deployed at any location to remediate soil. The soil enhancement composition may comprise microbes capable to degrading a contaminant. Degradation may comprise breaking chemical bonds of a compound. For example, the microbes may be capable of degrading an oil and/or hydrocarbon chain when dispersed onto an oil field. The soil enhancement composition may convert a hydrocarbon chain to short hydrocarbon chain and/or methane.

The microbes in the soil enhancement composition and/or soil enhancement mix may be grown within a bioreactor or the open-system bioreactor. The microbes may not need to be transported from an off-site location to the soil enhancement system.

The soil enhancement system may comprise a communication module. The communication module may receive data from, and transmit data to, the open-system bioreactor. The communication module may send and/or receive data from one or more sensors disposed within and/or in proximity to the open-system bioreactor. The sensors may measure parameters including, but not limited to, pressure, temperature, pH, gas level (e.g., oxygen and/or carbon dioxide), flow rate, circulation, mass transfer in and/or out of the open-system bioreactor, electrolyte concentration, contaminant concentration, reagent (e.g., sugar) level, or a combination thereof.

The communication module may comprise a modem and/or network router, a motherboard, a central processing unit, or a combination thereof. The modem and/or network router may be configured to communicate with a satellite, cellular, or other wireless network. Data received by the communication module may be transmitted to cloud storage system via the satellite, cellular, or other wireless network. The modem and/or network router may also be configured to communicate with a wired network or local access network.

The soil enhancement system may comprise a tote cover. The tote cover may be at least partially disposed over the open-system bioreactor. The tote cover may control heat and/or light entering the open-system bioreactor.

Embodiments of the present invention provide a technology-based solution that overcomes existing problems with the current state of the art in a technical way to satisfy an existing problem for farmers and/or agricultural experts. Embodiments of the present invention achieve important benefits over the current state of the art, such as providing a consistent flow of soil enhancement composition to an irrigated crop and/or field to improve soil integrity and/or crop yield. Some of the unconventional steps of embodiments of the present invention include using an open-system bioreactor to apply a soil enhancement composition to a target crop and/or field.

Note that in the specification and claims, “about” or “approximately” means within twenty percent (20%) of the numerical amount cited. The terms, “a”, “an”, “the”, and “said” mean “one or more” unless context explicitly dictates otherwise.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A soil enhancement system, the system comprising:
an open-system bioreactor;
a soil enhancement mix;
a soil enhancement composition; and
an irrigation system in communication with said open-system bioreactor.

2. The system of claim 1 further comprising an auto-fill device.

3. The system of claim 1 further comprising a recirculation pump.

4. The system of claim 1 further comprising an aerator.

5. The system of claim 1 wherein said soil enhancement composition comprises a microorganism.

6. The system of claim 5 wherein said microorganism is a bacteria.

7. The system of claim 5 wherein said microorganism is a fungi.

8. The system of claim 1 wherein said soil enhancement composition comprises a sugar.

9. The system of claim 1 wherein said soil enhancement composition comprises a bio-stimulant.

10. The system of claim 1 wherein said soil enhancement composition comprises a carbohydrate.

11. The system of claim 1 wherein said soil enhancement composition comprises carbon.

12. The system of claim 1 wherein said soil enhancement composition is at a pH of about 6.0 to about 9.0.

13. The system of claim 1 wherein said soil enhancement composition is at a temperature of about 45 degrees Fahrenheit to about 95 degrees Fahrenheit.

14. The system of claim 1 wherein said soil enhancement composition comprises a nitrogen fixing composition.

15. The system of claim 1 wherein said soil enhancement composition comprises a phosphate fixing composition.

16. The system of claim 1 further comprising a communication module.

17. A method of soil enhancement, the method comprising:
flowing fluid into an open-system bioreactor;
disposing a soil enhancement mix into an open-system bioreactor;
contacting the fluid with the soil enhancement mix to form a soil enhancement composition;
flowing the soil enhancement composition out of the open-system bioreactor; and
flowing the soil enhancement composition through an irrigation system.

18. The method of claim 17 further comprising aerating the soil enhancement composition.

19. The method of claim 17 further comprising recirculating the soil enhancement composition.

20. The method of claim 17 further comprising adjusting the pH of the soil enhancement composition.
